(19) United States
(12) Patent Application Publication
(10) Pub. No.: US 2022/0398666 A1
(43) Pub. Date: Dec. 15, 2022

(54) DISTRIBUTED LEDGER-BASED DECENTRALIZED AUTONOMOUS ORGANIZATIONS AND COLLABORATIONS

(71) Applicant: Kyodai Technologies Inc., d/b/a/ Rensa Games, Cheyenne, WY (US)

(72) Inventors: Anthony J. Apollo, Cheyenne, WY (US); Frank M. Apollo, Cheyenne, WY (US); Nicholas C. Apollo, Cheyenne, WY (US)

(21) Appl. No.: 17/838,378

(22) Filed: Jun. 13, 2022

Related U.S. Application Data
(60) Provisional application No. 63/210,197, filed on Jun. 14, 2021.

(51) Int. Cl. G06Q 40/06; G06Q 20/36

(52) U.S. Cl. CPC G06Q 40/06; G06Q 20/36; G06Q 2230/00

(57) ABSTRACT

Systems and methods for creating and managing decentralized autonomous organizations (DAOs) using distributed ledgers are provided. An investor can submit a proposal for disbursement of funds from the DAO for the creation of digital objects. The DAO can be associated with a set of voting share tokens that can be provided to the investors according to their contributions to the DAO. When investors use their tokens to vote on the proposal, a smart contract deployed to a distributed ledger for the DAO can review the votes and the corresponding tokens to determine if the proposal is approved. If so, funds from the DAO can be provided to content creators for the creation of digital objects that can be published to a digital object marketplace. Financial distributions resulting from the sale of these digital objects can be automatically provided to investors according to their respective voting share tokens.

### CROSS-REFERENCE TO RELATED APPLICATIONS

The present application claims priority benefit of U.S. provisional patent application No. 63/210,197 filed Jun. 14, 2021, the disclosure of which are incorporated by reference therein.

### FIELD

The present disclosure relates generally to systems and methods for creating and managing decentralized autonomous organizations using distributed ledgers and for the allocation and deployment of support for the development of digital objects.

### BACKGROUND

The global market for digital media (e.g., video games, digital images, digital video, digital audio, etc.) has expanded substantially over time. For instance, the global video game market has grown to $174.9 billion annually, with publishers and development companies posting record profits. However, these substantial gains have come at the expense of the content creators that generate the myriad digital objects that are used to create the digital media produced by these publishers and development companies. Further, creation of new digital media can require multidisciplinary teams, long hours, and significant capital. This may serve as barriers to small-scale creation of digital media, which, in turn, allow incumbent publishers and large development entities to monopolize talent and technology. As a result, it can be difficult for smaller groups or entities to raise and deploy capital to content creators for the creation of digital media in a more equitable manner.

### SUMMARY

Disclosed embodiments provide a framework for creating and managing decentralized autonomous organizations (DAOs) by leveraging smart contracts and distributed ledgers to raise capital and to deploy such capital for the creation of digital objects published to a digital object marketplace. An investor can submit a proposal for disbursement of funds from the DAO for the creation of digital objects. The DAO can be associated with a set of voting share tokens that can be provided to the investors according to their contributions to the DAO. When investors use their tokens to vote on the proposal, a smart contract deployed to a distributed ledger for the DAO can review the votes and the corresponding tokens to determine if the proposal is approved. If so, funds from the DAO can be automatically provided to recipient content creators for the creation of digital objects that can be published to a digital object marketplace. Financial distributions (e.g., revenue shares, royalties, etc.) resulting from the sale of these digital objects can be automatically provided to investors according to their respective voting share tokens.

According to some embodiments, a computer-implemented method is provided. The computer-implemented method comprises receiving a proposal for disbursement of funds from a DAO for creation of one or more digital objects. The DAO is associated with a set of investors. Further, the DAO is associated with a set of voting share tokens minted using a smart contract deployed to a distributed ledger for the DAO. The computer-implemented method further comprises providing the proposal to the set of investors. The computer-implemented method further comprises obtaining votes associated with the proposal. A vote indicates a response to the proposal and includes one or more voting share tokens of the set of voting share tokens. The computer-implemented method further comprises processing the votes associated with the proposal to determine whether the proposal is approved. Processing the votes includes evaluating voting share tokens submitted with the votes and corresponding responses to the proposal. The computer-implemented method further comprises, as a result of the votes indicating that the proposal is approved, disbursing the funds from the DAO for the creation of the one or more digital objects. The funds are disbursed by the smart contract from a digital wallet associated with the DAO.

In an example, a system comprises one or more processors and memory including instructions that, as a result of being executed by the one or more processors, cause the system to perform the processes described herein. In another example, a non-transitory computer-readable storage medium stores thereon executable instructions that, as a result of being executed by one or more processors of a computer system, cause the computer system to perform the processes described herein.

This summary is not intended to identify key or essential features of the claimed subject matter, nor is it intended to be used in isolation to determine the scope of the claimed subject matter. The subject matter should be understood by reference to appropriate portions of the entire specification of this patent application, any or all drawings, and each claim.

The foregoing, together with other features and examples, will be described in more detail below in the following specification, claims, and accompanying drawings.

### BRIEF DESCRIPTION OF THE DRAWINGS

The present disclosure is described in conjunction with the appended Figures:

FIG. 1 shows an illustrative example of an environment in which various embodiments can be implemented;

FIG. 2 shows an illustrative example of an environment in which a DAO including a set of investors is formed and used to raise and allocate funding for one or more content creators via a digital object marketplace in accordance with at least one embodiment;

FIG. 3 shows an illustrative example of an environment in which an investor associated with a DAO managed by a digital object marketplace is provided with a voting share token based on its contribution to an object fund pool for deployment of projects and governed using a smart contract in accordance with at least one embodiment;

FIG. 4 shows an illustrative example of an environment in which investors associated with a DAO submit votes using corresponding voting share tokens to determine whether to deploy funds from an object fund pool to one or more content creators for the creation and publishing of new digital objects in accordance with at least one embodiment;

FIG. 5 shows an illustrative example of a process for creating a new DAO in accordance with at least one embodiment;

FIG. 6 shows an illustrative example of a process for issuing voting share tokens to investors associated with a DAO in response to a determination that a funding threshold for the DAO has been met in accordance with at least one embodiment;

FIG. 7 shows an illustrative example of a process for approving a DAO proposal and allocating funds from the DAO to one or more content creators for the publishing of digital objects to the digital object marketplace in accordance with at least one embodiment;

FIG. 8 shows an illustrative example of a process for distributing financial distributions to investors associated with a DAO in response to receiving a payment for a license token associated with a digital object created using funds from the DAO in accordance with at least one embodiment; and

FIG. 9 shows an illustrative example of an environment in which various embodiments can be implemented.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

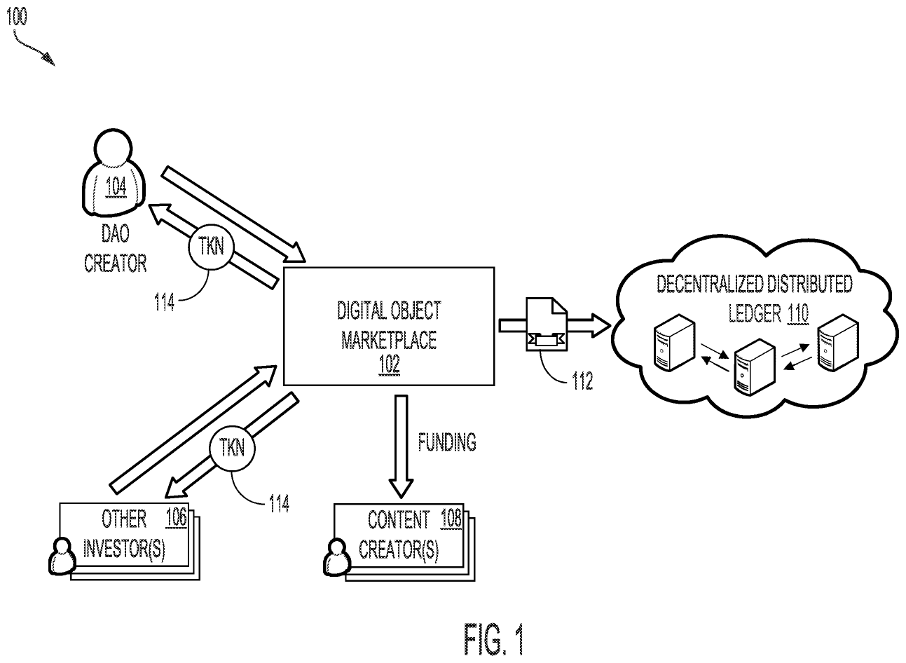

FIG. 1 shows an illustrative example of an environment 100 in which various embodiments can be implemented. In the environment 100, a DAO creator 104, using a computing device (e.g., desktop computer, laptop computer, tablet computer, smartphone, etc.) may submit a request to a digital object marketplace 102 to initialize the creation of a DAO. The digital object marketplace 102 may be an open peer-to-peer (P2P) digital exchange, through which independent content creators may list and monetize their digital objects via tokenized licenses. Licensees may purchase a license token for a digital object from the digital object marketplace 102 and, accordingly, leverage this digital object to develop new, derivative digital objects in a collaborative manner. The digital object marketplace 102 may be implemented as a digital platform, utilizing computer systems and applications as a backend to manage digital objects on behalf of content creators, furnish owner tokens to content creators upon digital object upload (and/or implement alternative methods of tracking and executing financial distributions, such as designating recipient wallet addresses described in greater detail herein), furnish license tokens to licensees upon purchase, and distributing corresponding payments to content creators automatically and in real-time using a decentralized distributed ledger 110.

An owner token may designate a content creator as the originator of a digital object. The owner token may be issued and held by the content creator in its digital wallet and recorded in the decentralized distributed ledger 110. In an embodiment, the object owner token is transferrable to other users of the digital object marketplace 102. For instance, a content creator can sell the object owner token to another user at an agreed upon price. The transaction may be processed using the decentralized distributed ledger 110 and recorded therein. The other user, now the holder of the object owner token, may automatically, and in real-time, receive any payments generated through the sale of tokenized licenses associated with the digital object and any financial distributions generated by the tokenized licenses linked to the object owner token.

A license token for a digital object may be generated automatically when a smart contract corresponding to the digital object is deployed to the decentralized distributed ledger 110 and provided to the digital wallet owned and maintained by the digital object marketplace 102 on behalf of the content creator. When a licensee purchases a license to the digital object via the digital object marketplace 102, the digital object marketplace 102 may automatically transfer a license token from its digital wallet to the digital wallet of the licensee. This transaction may be recorded in the decentralized distributed ledger 110. In an embodiment, an object license token can be generated at the point-of-sale (e.g., when the licensee submits a request to purchase a license to the digital object) by the smart contract and automatically transferred to the licensee's digital wallet.

In an embodiment, through the digital object marketplace 102, the DAO creator 104 can define a purpose statement of other description for the DAO that is to be created, specify the minimum number of investors that may join the DAO, and the minimum investment amount required from the investors in order to successfully launch the DAO. The minimum investment amount may be defined using units of a cryptocurrency. For instance, the digital object marketplace 102 may prompt the DAO creator 104 to specify an amount of ether, or ETH (if the decentralized distributed ledger 110 is implemented using the Ethereum blockchain), that is to serve as the minimum investment amount required from the investors in order to successfully launch the DAO. In some instances, the DAO creator 104 may define a minimum investment amount for each investor that wishes to join the DAO in addition to the minimum investment amount required from the investors in total in order to successfully launch the DAO. Further, in some instances, the DAO creator 104 may define a maximum investment amount or threshold for each investor that wishes to join the DAO. This maximum investment amount or threshold may be implemented to prevent any one investor from monopolizing the DAO, as described in greater detail herein.

In response to the request from the DAO creator 104 to create the new DAO, the digital object marketplace 102 may publicly list the new DAO via a website or web portal provided by the digital object marketplace 102. This may allow users of the digital object marketplace 102 to view any open DAOs and determine whether to invest in a particular DAO. In an embodiment, when the DAO creator 104 submits its request to create the new DAO, the digital object marketplace 102 generates an object fund pool for the DAO, which may be used to pool investments from any investor joining and contributing to the DAO. In an embodiment, the object fund pool for the open DAO may be maintained via the decentralized distributed ledger 110. For instance, the digital object marketplace 102 may create a digital wallet for the DAO via the decentralized distributed ledger 110 that may be used as the object fund pool for the DAO. In an embodiment, the digital wallet is a software-based cryptocurrency wallet that is used to interact with a decentralized distributed ledger 110.

The decentralized distributed ledger 110 may be a decentralized database managed by various members across multiple nodes. This decentralized database may be shared, replicated, and synchronized amongst these various members within a decentralized network. These members within the decentralized network may govern and agree by consensus on updates to the records in the distributed ledger 110. The decentralized distributed ledger 110 is, thus, decentralized by virtue of having no central authority or mediator involved in the governance of the distributed ledger. Each record that is maintained in the decentralized distributed ledger 110 may have a timestamp and unique cryptographic signature, which may be used to audit the distributed ledger 110 and to provide a comprehensive history of transactions within the decentralized network. As contemplated herein, any type of decentralized distributed ledger 110 may be used that supports the creation and implementation of smart contracts and for the recording of transactions and distribution of payments amongst users of the digital object marketplace 102. Thus, the decentralized distributed ledger 110 may include a public or private blockchain, Hashgraph, Directed Acyclic Graph (DAG), Holochain, Radix Tempo, and the like.

In an embodiment, in addition to generating a digital wallet for the DAO, the digital object marketplace 102 may deploy a smart contract 112 to the decentralized distributed ledger 110 for the DAO. For instance, in response to the DAO creator's 104 request to create a new DAO, the digital object marketplace 102 may map the parameters for the DAO (e.g., minimum investment amount for the DAO, threshold investment amounts per investor, minimum number of investors required, etc.) to a smart contract 112. A smart contract 112 may be a collection of programmatic code and data that may reside at a specific address on the decentralized distributed ledger 110. The smart contract 112 may serve as a type of account within the decentralized distributed ledger 110, whereby the smart contract 112 may have a balance and may transmit transactions over the decentralized network. The smart contract 112 may be deployed to the decentralized network of the decentralized distributed ledger 110 and may function as programmed by the digital object marketplace 102. The digital object marketplace 102 may interact with the smart contract 112 by submitting transactions on behalf of users that execute one or more functions defined in the smart contract. This may include allocating funds to the digital wallet associated with the DAO, distributing funds to content creators 108 for the creation of digital objects, issuing tokens 114 to the DAO creator 104 and other investors 106 that represent each investor's voting share within the DAO, distributing payments to investors (e.g., the DAO creator 104 and the other investors 106) according to their voting share, and the like.

In an embodiment, the digital object marketplace 102 can allow investors (such as other investors 106) to contribute to the DAO using an amount of cryptocurrency and/or fiat currency (e.g., United States Dollar, Euro, Yen, etc.). If an investor 106 submits an investment using a fiat currency, the digital object marketplace 102 may automatically convert the specified fiat currency amounts into corresponding units of a cryptocurrency associated with the decentralized distributed ledger 110 in real-time when transactions are performed. For instance, when an investor 106 opts to submit an investment to the DAO using a fiat currency, the digital object marketplace 102 may, in real-time, determine an exchange rate between the fiat currency used to define the investment amount and the cryptocurrency associated with the decentralized distributed ledger 110. The conversion may be presented to the investor 106, which may allow the investor 106 to determine whether to proceed with the investment.

In an embodiment, as other investors 106 submit contributions to the open DAO, the digital object marketplace 102, via the smart contract 112, may determine whether the DAO has reached its funding threshold. As noted above, the DAO creator 104 may define a funding threshold (e.g., minimum investment amount) for the DAO, which may be mapped to the smart contract 112 deployed to the decentralized distributed ledger 110 for the DAO. Accordingly, as investments are received for the DAO, the smart contract 112 may track the total investment amount submitted and the contribution of each investor 106 made to the DAO. In an embodiment, each investor 106 can only contribute to a given DAO once, and the smart contract 112 can automatically provide, to the digital object marketplace 102, the percentage of the total investment amount received that each investor 106 has contributed and, accordingly, is entitled to. This information may be provided by the digital object marketplace 102 to all investors 104, 106 of the DAO, as well as to any user of the digital object marketplace 102 that may be interested in investing in the DAO.

In an alternative embodiment, each investor 106 can contribute any number of times to a given DAO subject to any funding thresholds. For instance, the DAO creator 104 may define a funding threshold for individual investors 106, whereby no investor to the DAO may contribute an amount that exceeds the funding threshold. In some instances, an investor 106 may define an individual or personal funding threshold, whereby the investor 106 may only contribute to the DAO and any other DAOs up to the individual or personal funding threshold. Further, the funding threshold may be defined by an applicable regulatory entity. For example, a regulatory entity may define a funding constraint whereby investors can only invest up to a certain percentage of their annual income. Thus, an investor 106 can continue to contribute to the DAO as needed subject to the one or more funding thresholds corresponding to the DAO until the funding threshold for the DAO has been reached and the DAO is closed to further investment.

In an embodiment, once the funding threshold has been reached for the DAO, the smart contract 112 can close the DAO such that no more capital (e.g., investments) can be committed to the DAO. In other words, the smart contract 112 may lock the obtained funds. In some instances, once the DAO has been closed, investors 106 may be locked into the DAO, whereby investments made into the DAO may not be returned to investors 106 unless they sell their share of the DAO to another entity. Further, the smart contract 112 can generate, or mint, voting share tokens 114 that may be issued to the various investors 104, 106 of the DAO. In an embodiment, the smart contract 112 can mint a voting share token 114 for each investor 104, 106, whereby a voting share token 114 for a particular investor may encode the investor's voting power. An investor's voting power may correspond to the contribution of the investor to the object fund pool for the DAO. For example, an investor contributing a greater investment amount may receive a voting share token 114 that provides the investor with a greater voting power compared to another investor that did not contribute as much to the object fund pool. Thus, some voting share tokens 114 may provide greater voting power compared to others. In some instances, rather than minting a voting share token 114 for each investor 104, 106, the smart contract 112 can mint voting share tokens 114 in proportion to the total funding amount in the object fund pool. Each investor 104, 106 may receive a number of voting share tokens 114 proportional to the amount invested by the investor. Thus, an investor that contributed a greater investment amount may receive a greater number of voting share tokens 114.

Once the DAO has been successfully funded, an investor may submit proposals on which projects or digital objects that may be published to the digital object marketplace 102 the investor would like to see funded. For instance, an investor may submit a proposal to allocate an amount of funds from the object fund pool to specific digital object types (e.g., horror-themed three-dimensional (3-D) objects), motion capture animations, etc.). As another example, an investor may submit a proposal to allocate an amount of funds from the object fund pool to individual content creators 108 for the creation of digital objects. Investors may also submit proposals to allocate an amount from the object fund pool to independent developers, development studios, and other entities. In some embodiments, an investor can submit a proposal to generate a bounty to incentivize the development of different digital media, such as video games. In some instances, investors can also submit proposals to fund new franchises.

If an investor submits a proposal for funding a new project or creation of a digital object, the digital object marketplace 102 may present the proposal to all investors associated with the DAO. For instance, when a proposal is received for use of funds from the DAO, the digital object marketplace 102 may automatically notify each investor 104, 106 associated with the DAO to indicate that a new proposal has been received. An investor may access the digital object marketplace 102 to review the new proposal and determine whether to vote for or against the proposal using its voting share token(s) 114. As each investor 104, 106 votes for or against the new proposal, the smart contract 112 may receive these votes and the voting share tokens 114 for the investors 104, 106. Further, the smart contract 112 may determine, based on these votes, whether the proposal has passed. For instance, the smart contract 112 may tally each vote according to the voter's (e.g., investor's) voting share, as determined based on the voter's contribution to the object fund pool.

In an embodiment, approval of a proposal may be subject to one or more requirements as defined by the DAO creator 104, as agreed upon by the investors 104, 106 of the DAO, or by default by the digital object marketplace 102. For instance, a proposal may be approved when votes corresponding a particular percentage of the voting share satisfy a minimum threshold value. For example, if 51% of the voting shares are used to indicate approval of a proposal, the proposal may be considered approved. However, if the minimum threshold value is 60% of the voting shares for approval of a particular proposal, receipt of 51% of voting shares indicating approval of the proposal would result in the particular proposal being rejected.

In an embodiment, participation from a minimum number of investors 104, 106 or a quorum is required for the vote on the proposal to be valid. For instance, as votes (e.g., voting share tokens 114) are received for a particular proposal, the smart contract 112 may determine whether a quorum of DAO investors have participated in the vote for the proposal. If a quorum is met, the vote on the proposal is considered valid and the smart contract 112 may proceed to determine whether funding of the proposal has been approved by the investors 104, 106. However, if a quorum is not met within a specified period of time, the smart contract 112 may determine that there is no vote on the proposal and the proposal is considered rejected.

In an embodiment, if the smart contract 112 determines that a proposal has been approved, the smart contract 112 can automatically deploy funds from the digital wallet associated with the DAO to the intended recipient (e.g., content creator 108, independent developer, etc.). For instance, if the intended recipient is a content creator 108 or independent developer, the smart contract 112 can automatically, and autonomously, transfer funds from the digital wallet associated with the DAO to the content creator's 108 or independent developer's digital wallet and the transaction may be recorded in the decentralized distributed ledger 110.

In an embodiment, investors 104, 106 can vote to create a separate allocation of funds in the object fund pool for deployment of these funds according to the passed proposal. These funds, in the object fund pool, may remain in escrow until a content creator 108 or independent developer submits the required digital objects to the digital object marketplace 102. Once the required digital objects are published, the investors 104, 106 may be notified of the publishing of these digital objects. The investors 104, 106 may review the digital objects and vote to approve or deny the disbursement of funds from the object fund pool to the content creator 108 or independent developer for the digital objects. If approved, the digital objects may be listed as available through the digital object marketplace 102 and each investor 104, 106 may receive a pro rata share of revenues from sales of the digital objects (in addition to the content creator 108 or independent developer). These pro rata shares may be defined in a smart contract for the digital object and the pro rata shares may correspond to the initial investment amounts submitted by the investors 104, 106 for the DAO. As an illustrative example, when a digital object is sold via the digital object marketplace 102, the smart contract for the digital object may automatically transfer a pro rata financial distribution amount to each investor 104, 106 as a return on their investment through the DAO to a given project or digital object.

In an embodiment, an investor 104, 106 can be permitted to transfer their voting share token(s) 114 to other users of the digital object marketplace subject to any restrictions imposed by the DAO creator 104 or by the DAO itself. For instance, an investor can sell its voting share token(s) to another user at an agreed upon price. The transaction may be processed using the decentralized distributed ledger 110 and recorded therein. The other user, now the holder of the voting share token(s) 114, may automatically, and in real-time, participate in the DAO (e.g., vote on proposals, etc.), receive any financial distributions generated through the sale of digital objects generated using funds from the DAO, and the like. The restrictions on the transfer of voting share token(s) 114 may include any lockup periods for transfers, maximum voting share thresholds (e.g., no digital address corresponding to an investor 104, 106 may hold voting share tokens 114 in excess of a threshold amount or otherwise control a voting share greater than a threshold amount), and the like.

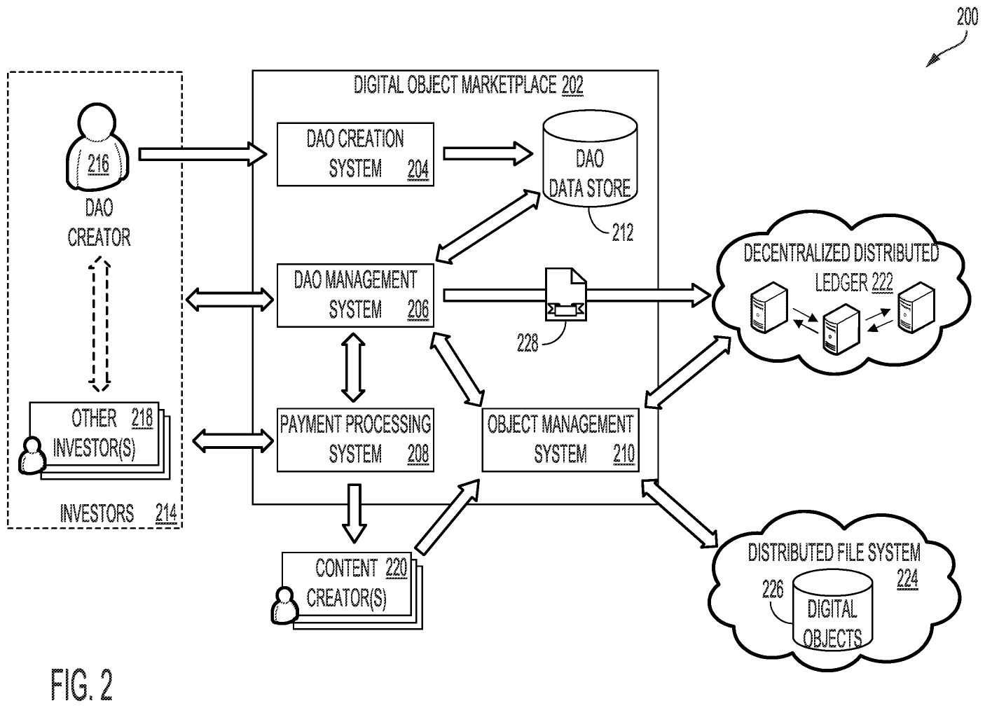

FIG. 2 shows an illustrative example of an environment 200 in which a DAO including a set of investors 214 is formed and used to raise and allocate funding for one or more content creators 220 via a digital object marketplace 202 in accordance with at least one embodiment. In the environment 200, the digital object marketplace 202 may include a DAO creation system 204, which may allow users of the digital object marketplace 202, such as DAO creator 216, to create a DAO and solicit investments to the DAO for the funding of projects and/or digital objects that may be published to the digital object marketplace 202. The DAO creation system 204 may be implemented using a computer system of the digital object marketplace 202 or as an application or code executing on one or more computer systems of the digital object marketplace 202. In an embodiment, the DAO creation system 204 may be implemented using executable code that, when executed, autonomously creates a new data structure defining the DAO parameters.

In an embodiment, the digital object marketplace 202, through the DAO creation system 204, provides users with an interface and platform through which users can create and manage DAOs. For instance, a DAO creator 216 can utilize the DAO creation system 204 to define one or more parameters (e.g., minimum investment amount for the DAO, threshold investment amounts per investor, minimum number of investors required, etc.) for the new DAO. For instance, a DAO creator 216 may define a minimum investment amount that must be contributed by investors 214 in order for the DAO to be considered funded. As another example, the DAO creator 216 may define the minimum and maximum investment amounts that may be contributed by an individual investor in order to participate in the DAO. Further, in some instances, the DAO creator 216 may specify how many investors 214 are required for the DAO in order to provide proper democratization of the DAO for voting on proposals and investments using funds allocated to the DAO.

Once a DAO creator 216 has created a new DAO via the DAO creation system 204, the DAO creation system 204 may store the parameters of the new DAO in a DAO data store 212. The DAO data store 212 may serve as a database including entries for each DAO created via DAO creation system 204 and presented to users by the digital object marketplace 202. For instance, the DAO data store 212 may be utilized by a DAO management system 206 of the digital object marketplace 202 to identify the DAOs created by DAO creators (such as DAO creator 216) to seek investment for different projects and/or digital objects. An entry in the DAO data store 212 may include an identifier for the corresponding DAO and the different DAO parameters defined by the DAO creator 216 for the DAO. The DAO management system 206 may be implemented using a computer system of the digital object marketplace 202 or as an application or code executing on one or more computer systems of the digital object marketplace 202.

The DAO management system 206 may use the parameters defined for the newly created DAO to generate a smart contract 228 for the DAO. The DAO management system 206 may deploy the smart contract 228 to a decentralized distributed ledger 222 for the DAO. For instance, in response to the DAO creator's 216 request to create a new DAO, the DAO management system 206 may map the parameters for the DAO (e.g., minimum investment amount for the DAO, threshold investment amounts per investor, minimum number of investors required, etc.) to a smart contract 228.

The DAO management system 206 may allow investors 214 (e.g., the DAO creator 216 and any other investors 218) to contribute to the DAO using an amount of cryptocurrency and/or fiat currency. When an investor 214 submits a request to the DAO management system 206 to invest in the DAO, the DAO management system 206 may transmit a payment request to a payment processing system 208 of the digital object marketplace 202 for incorporation into the object fund pool for the DAO and to obtain any corresponding voting share tokens according to the terms specified in the smart contract 228. The payment processing system 208 may be implemented using a computer system of the digital object marketplace 202 or as an application or code executing on one or more computer systems of the digital object marketplace 202. The payment processing system 208, via the DAO management system 206, may transmit the investment request and an identity token corresponding to the investor's 214 digital wallet to the smart contract 228 deployed to the decentralized distributed ledger 222 for processing of the investment. The smart contract 228, in response, may determine whether the investment may be processed according to the parameters defined by the DAO creator 216 for the DAO. For instance, if the investment amount exceeds the maximum threshold amount specified by the DAO creator 216, the investment may be rejected. Similarly, if the investor has previously submitted an investment to the DAO, the new investment may also be rejected. As another example, if processing of the investment would result in the investor having a voting share greater than a maximum threshold amount, the investment may also be rejected.

If the investment is approved by the smart contract 228, the smart contract 228 may determine whether a funding threshold has been reached for the DAO. For instance, as investors 214 submit investment contributions to the DAO, the smart contract 228 may determine whether the DAO has reached its funding threshold. For example, as investments are received for the DAO, the smart contract 228 may track the total investment amount submitted and the contribution of each investor 214 made to the DAO. As noted above, each investor 214, in some instances can only contribute to a given DAO once. Alternatively, an investor 214 can contribute as many times as so desired subject to any contribution thresholds defined for the DAO and/or the investor 214. Based on these contribution(s), the smart contract 228 can automatically provide, to the DAO management system 206, the percentage of the total investment amount received that each investor has contributed and, accordingly, is entitled to. This information may be provided by the DAO management system 206 to all investors 214 of the DAO, as well as to any user of the digital object marketplace 202 that may be interested in investing in the DAO.

Once the funding threshold has been reached for the DAO, the smart contract 228 can close the DAO such that no more investments may be committed to the DAO. Further, the smart contract 228 can mint voting share tokens that may be issued to the various investors 214 of the DAO. In an embodiment, the smart contract 228 can mint a voting share token for each investor 214, whereby a voting share token for a particular investor 214 may encode the investor's 214 voting power or share. An investor's 214 voting power or share may correspond to the contribution of the investor 214 to the object fund pool for the DAO. As a result, some voting share tokens may provide greater voting power compared to others. In some instances, rather than minting a voting share token for each investor 214, the smart contract 228 can mint voting share tokens in proportion to the total funding amount in the object fund pool. Each investor 214 may receive a number of voting share tokens proportional to the amount invested by the investor 214.

An investor 214, through the DAO management system 206, can submit proposals on which projects or digital objects that may be published to the digital object marketplace 202 the investor would like to see funded. For instance, investors 214 may submit proposals to allocate an amount of funds from the object fund pool of the DAO to specific digital object types. As another example, investors 214 may submit proposals to allocate an amount of funds from the object fund pool to individual content creators 220 for the creation of digital objects. Investors 214 may also submit proposals to allocate an amount from the object fund pool to independent developers, development studios, and other entities. In some embodiments, investors 214 can submit proposals to generate a bounty to incentivize the development of different digital media, such as video games. In some instances, investors 214 can also submit proposals to fund new franchises.

When an investor 214 submits a proposal via the DAO management system 206, the DAO management system 206 may notify the investors 214 associated with the DAO of the new proposal and present this new proposal to the investors 214 accordingly. For instance, when a proposal is received for use of funds from the DAO, the DAO management system 206 may automatically notify each investor 214 associated with the DAO to indicate that a new proposal has been received. An investor 214 may access the DAO management system 206 to review the new proposal and determine whether to vote for or against the proposal using its voting share token(s). As each investor votes for or against the new proposal, the DAO management system 206 may transmit these votes to the smart contract 228, which may receive these votes and the voting share tokens for the investors 214. Further, the smart contract 228 may determine, based on these votes, whether the proposal has passed.

If the smart contract 228 determines that a proposal has been approved, the smart contract 228 can automatically deploy funds from the digital wallet associated with the DAO to the intended recipient (e.g., content creator 220, independent developer, etc.). For instance, if the intended recipient is a content creator 220 or independent developer, the smart contract 228 can automatically, and autonomously, transfer funds from the digital wallet associated with the DAO to the content creator's 220 or independent developer's digital wallet and the transaction may be recorded in the decentralized distributed ledger 222. Alternatively, if a proposal is approved, the smart contract 228 can hold the funds in the digital wallet associated with the object fund pool in escrow until a content creator 220 or independent developer submits the required digital objects to an object management system 210 of the digital object marketplace 202 for publishing of the digital objects. The object management system 210 may be implemented using a computer system of the digital object marketplace 202 or as an application or code executing on one or more computer systems of the digital object marketplace 202.

In an embodiment, when a content creator 220 uploads one or more digital objects to the object management system 210 according to the terms in an approved proposal from the DAO, the DAO management system 206 may notify the investors 214 of the DAO that the content creator 220 has uploaded these digital objects to the object management system 210 for review and approval. The investors 214 may review the digital objects and vote to approve or deny the disbursement of funds from the object fund pool to the content creator 220 or independent developer for the digital objects. If approved, the object management system 210 may store the digital objects in a digital object store 226 within a distributed file system 224. The distributed file system 224 may rely on cryptographic hashes that can be stored in a distributed ledger, such as decentralized distributed ledger 222. The distributed file system 224 may utilize content-addressing to uniquely identify each digital object stored in the digital object store 226 using a global namespace connecting various devices within the decentralized network. Similar to the decentralized distributed ledger 222, the distributed file system 224 may be implemented using a decentralized network of operators that may maintain portions of the overall data. A user of the distributed file system 224 may serve a digital object by its corresponding content address, allowing other users in the network to find and request the digital object from any node that maintains the digital object using a distributed hash table. Examples of distributed file systems include InterPlanetary File System (IPFS), Arweave, Storj, Filecoin, Sun Microsystems® Network File System (NFS), Microsoft® Distributed File System, IBM® Distributed File Service (DFS), Amazon® Simple Storage Service (S3), and the like.

When a digital object is stored in the distributed file system 224, the digital object may be listed as available through the digital object marketplace 202. Further, when a digital object is sold via the digital object marketplace 202, each investor 214 may receive a pro rata share of revenues from sales of the digital objects (in addition to the content creator 220 or independent developer). These pro rata shares may be defined in a smart contract for the digital object and the pro rata shares may correspond to the initial investment amounts submitted by the investors 214 for the DAO. As an illustrative example, when a digital object is sold via the digital object marketplace 202, the smart contract for the digital object may automatically transfer a pro rata financial distribution amount to each investor as a return on their investment through the DAO to a given project or digital object.

As noted above, an investor may be able to transfer their voting share token(s) to other users of the digital object marketplace 202 subject to any restrictions imposed by the DAO creator 216 or by the DAO itself. For instance, an investor can sell its voting share token(s) to another user at an agreed upon price. The transaction may be processed using the smart contract 228 deployed to the decentralized distributed ledger 222 and recorded therein. The other user, now the holder of the voting share token(s), may automatically, and in real-time, participate in the DAO (e.g., vote on proposals, etc.), receive any financial distributions generated through the sale of digital objects generated using funds from the DAO, and the like. The restrictions on the transfer of voting share token(s) may include any lockup periods for transfers (as mandated by regulators or as defined in a set of regulations for securities transfers, etc.), maximum voting share thresholds (e.g., no digital address corresponding to an investor may hold voting share tokens in excess of a threshold amount or otherwise control a voting share greater than a threshold amount), and the like.

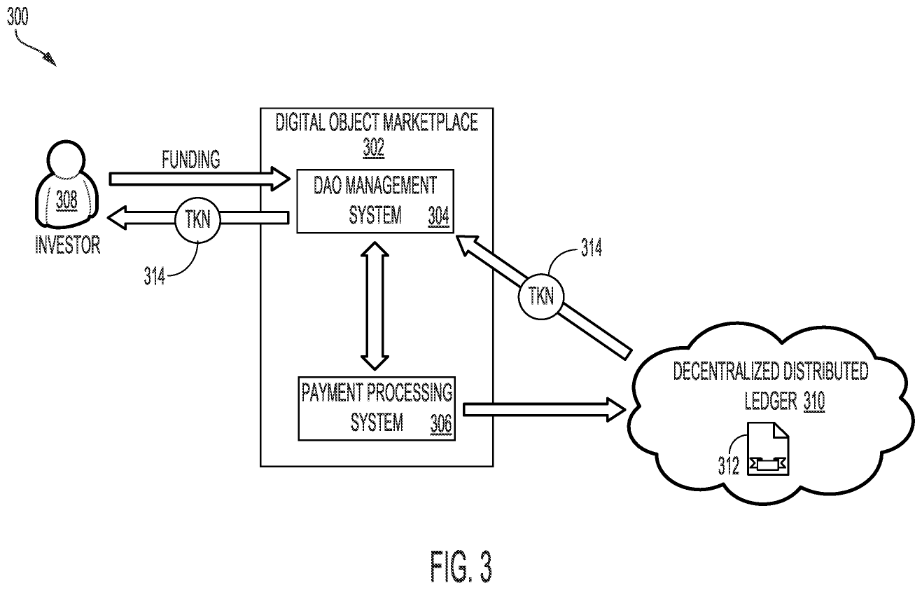

FIG. 3 shows an illustrative example of an environment 300 in which an investor 308 associated with a DAO managed by a digital object marketplace 302 is provided with a voting share token 314 based on its contribution to an object fund pool for deployment of projects and governed using a smart contract 312 in accordance with at least one embodiment. In the environment 300, an investor 308 may submit an investment to a DAO management system 304 of the digital object marketplace 302 to provide funding to a DAO and to obtain a voting share token 314 that may be used by the investor 308 to participate in the DAO. The DAO management system 304 may be similar to the DAO management system 206 described above in connection with FIG. 2. The investment submitted by the investor 308 may be subject to one or more conditions for investment into the DAO presented to the investor 308 via the website or web portal provided by the digital object marketplace 302 and defined by a DAO creator. As noted above, these one or more conditions may include a minimum and/or maximum investment amount or threshold for each investor that wishes to join the DAO. This maximum investment amount or threshold may be implemented to prevent any one investor from monopolizing the DAO.

In response to the request from the investor 308 to invest in the DAO, the DAO management system 304 may provide, to the payment processing system 306, a payment request for processing of the investor's 308 investment in the DAO. The payment processing system 306, based on an identifier corresponding to the DAO provided by the DAO management system 304, may access the digital wallet corresponding to the DAO to ensure that the digital wallet is available for adding the investment from the investor 308. Further, the payment processing system 306 may access the investor's digital wallet to obtain an identity token corresponding to the investor 308. The payment transaction system 306 may provide the identifier of the DAO, the investor's 308 identity token, and the transaction request to the smart contract 312 deployed to the decentralized distributed ledger 310 for the DAO.

In response to the investment request, the smart contract 312 may determine whether the investment may be added to the digital wallet corresponding to the DAO. As noted above, the smart contract 312, in response to the investment request, may determine whether the investment may be processed according to the parameters defined by the DAO creator for the DAO. For instance, if the investment amount exceeds the maximum threshold amount specified by the DAO creator, the investment may be rejected. Similarly, if the investor 308 has previously submitted an investment to the DAO, and the DAO is subject to a restriction whereby investors may only contribute once to the DAO, the new investment may also be rejected. As another example, if the investor 308 has already contributed an amount to the DAO (through any number of contributions) up to a personal maximum contribution threshold, the new investment may be rejected. As yet another example, if processing of the investment would result in the investor 308 having a voting share greater than a maximum threshold amount, the investment may also be rejected.

If the investment may be added to the digital wallet corresponding to the DAO, the smart contract 312 may transfer the corresponding investment amount from the investor's digital wallet 308 to the digital wallet corresponding to the DAO. This transfer may be recorded by the smart contract 312 into the decentralized distributed ledger 310. Additionally, the smart contract 312 may generate, or mint, one or more voting share tokens 314 that may be issued to the investor 308. The smart contract 312 may provide the voting share tokens 314 to the DAO management system 304 which, in turn, may add the one or more voting share tokens 314 to the investor's digital wallet. In some instances, rather than providing the one or more voting share tokens 314 to the DAO management system 304, the smart contract 312 may automatically add the one or more voting share tokens 314 to the investor's digital wallet.

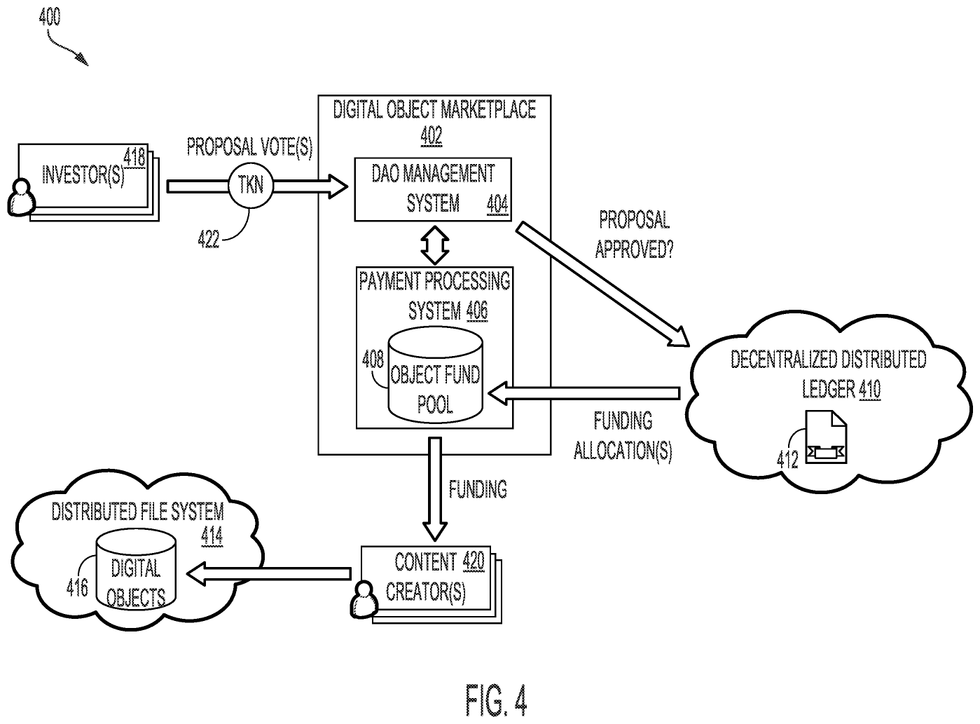

FIG. 4 shows an illustrative example of an environment 400 in which investors 418 associated with a DAO submit votes using corresponding voting share tokens 422 to determine whether to deploy funds from an object fund pool 408 to one or more content creators 420 for the creation and publishing of new digital objects in accordance with at least one embodiment. In the environment 400, a set of investors 418 associated with a DAO may review a proposal submitted by an investor in association with the DAO to allocate funding from the object fund pool 408 to one or more content creators 420 for the creation of new digital objects. As noted above, once a DAO has been successfully funded, an investor may submit proposals on which projects or digital objects that may be published to the digital object marketplace 402 the investor would like to see funded. Investors 418 may also submit proposals to allocate an amount from the object fund pool 408 to independent developers, development studios, and other entities. In some embodiments, an investor can submit a proposal to generate a bounty to incentivize the development of different digital media, such as video games. In some instances, investors can also submit proposals to fund new franchises.

When a new proposal is submitted to the DAO management system 404, the DAO management system 404 may present the proposal to all investors 418 associated with the DAO. For instance, when a proposal is received for use of funds from the DAO, the DAO management system 404 may automatically notify each investor 418 associated with the DAO to indicate that a new proposal has been received. An investor may access the DAO management system 404 to review the new proposal and determine whether to vote for or against the proposal using its voting share token(s) 422. For instance, via an interface provided by the DAO management system 404, an investor may indicate whether it approves or rejects the proposal submitted to the DAO. In an embodiment, when the investor indicates its approval or rejection of the proposal, the DAO management system 404 can access the investor's digital wallet to evaluate the investor's one or more voting share tokens 422 that may be used to denote the investor's voting share for the proposal. For instance, if an investor has a 25% voting share within the DAO, the one or more voting share tokens 422 allocated to the investor may correspond to the investor's 25% voting share.

In an embodiment, the DAO management system 404 transmits, to the smart contract 412 deployed to the decentralized distributed ledger 410 for the DAO, an investor's vote for or against a particular proposal and the investor's corresponding voting share token(s). As votes corresponding to the proposal are received, the smart contract 412 can determine whether the proposal has been approved or rejected. For instance, as noted above, in order for a proposal to be approved, a minimum number of investors 418 may be required for the vote on the proposal to be valid. In some instances, in order for a proposal to be approved, a quorum of investors 418 may be required for the vote on the proposal to be valid. In yet other instances, the smart contract 412 may determine whether a requisite amount of voting share power has been detected amongst the investors 418 that have submitted votes in order to determine whether the vote on the proposal is valid. Thus, in order for the smart contract 412 to determine whether the proposal is approved, it is to first determine whether one or more criteria for the vote to be considered valid have been satisfied.

In an embodiment, the smart contract 412 can impose a time limit for receiving votes from investors 418 for a proposal. For instance, investors 418, via the DAO management system 404, may be provided with a time limit to submit a vote for a particular proposal submitted to the DAO. If an investor fails to provide a vote within the time limit, the investor may be considered as having abstained from voting on the proposal and its vote and voting share are ignored by the DAO management system 404 and the smart contract 412. Once the time limit has passed, the smart contract 412 may determine whether the one or more criteria for the vote to be considered valid have been satisfied. If the one or more criteria for the vote to be considered valid have not been satisfied, the smart contract 412 may reject the proposal and transmit a notification to the DAO management system 404 to indicate that the proposal has been rejected by the DAO.

If the one or more criteria required for the vote on the proposal to be valid are satisfied, the smart contract 412 may proceed to determine whether the proposal has been approved by the set of investors 418. For instance, the smart contract 412 may process each received vote, as well as the corresponding voting share token(s) 422 corresponding to the vote, and tally these votes according to their corresponding voting shares to determine whether the proposal has passed. As noted above, approval of a proposal may be subject to one or more requirements as defined by a DAO creator, as agreed upon by the investors 418, or as defined by default by the digital object marketplace 402. For instance, if the smart contract 412 has received approval from investors 418 corresponding to a 51% voting share of the DAO, and proposals are approved if a simple majority of the voting share indicates approval, the smart contract 412 may consider the proposal as having been approved by the investors 418. However, if the proposal is approved if at least 60% voting share of the DAO indicates approval, the proposal may be rejected if only 51% voting share indicating approval is received.

If the smart contract 412 determines that a proposal has been approved, the smart contract 412 can automatically deploy funds from the digital wallet associated with the DAO to the intended recipient (e.g., content creator 420, independent developer, etc.). For instance, if the intended recipient is a content creator 420 or independent developer, the smart contract 412 can automatically, and autonomously, transfer funds from the digital wallet associated with the DAO to the content creator's 420 or independent developer's digital wallet and the transaction may be recorded in the decentralized distributed ledger 410. Alternatively, if a proposal is approved, the smart contract 412 can hold the funds from the digital wallet associated with the object fund pool 408 maintained by the payment processing system 406 in escrow until a content creator 420 or independent developer submits the required digital objects to an object management system of the digital object marketplace 402 for publishing of the digital objects, as described above.

In an embodiment, when a content creator 420 or independent developer submits new digital objects according to the criteria defined in the proposal, the DAO management system 404 can notify the investors 418 of the availability of these new digital objects for review. Through the DAO management system 404, the investors 418 may review the digital objects and vote to approve or deny the disbursement of funds from the object fund pool 408 to the content creator 420 or independent developer for the digital objects. The voting process for the disbursement of funds from the object fund pool 408 may be similar to the voting process for approving proposals as described above. For instance, investors 418 may submit their votes to the DAO management system 404, which may provide these votes and corresponding voting share tokens 422 to the smart contract 412 to determine whether disbursement of funds from the object fund pool 408 to the content creator 420 or independent developer should be performed.

If the digital objects are approved by the investors 418, the object management system of the digital object marketplace 402 may store the digital objects in a digital object store 416 within a distributed file system 414. As noted above, the distributed file system 414 may rely on cryptographic hashes that can be stored in a distributed ledger, such as decentralized distributed ledger 410. The distributed file system 414 may utilize content-addressing to uniquely identify each digital object stored in the digital object store 416 using a global namespace connecting various devices within the decentralized network. Once the digital objects are published to the digital object marketplace 402 via the distributed file system 414, the payment processing system 406 may disburse the funds from the object fund pool 408 to the content creator 420 or independent developer. For instance, the payment processing system 406 may transfer funds from a digital wallet corresponding to the object fund pool 408 to the digital wallet of the content creator 420 or independent developer in accordance with the approved proposal. This transaction may be recorded in the decentralized distributed ledger 410.

In addition to disbursing funds from the object fund pool 408 to the content creator 420 or independent developer, the digital object marketplace 402 may list the digital objects as being available through the digital object marketplace 402 and each investor 418 may receive a pro rata share of revenues from sales of the digital objects (in addition to the content creator 420 or independent developer). These pro rata shares may be defined in a smart contract for the digital objects and the pro rata shares may correspond to the initial investment amounts submitted by the investors 418 for the DAO. As an illustrative example, when a digital object is sold via the digital object marketplace 402, the smart contract for the digital object may automatically transfer a pro rata financial distribution amount to each investor 418 as a return on their investment through the DAO to a given project or digital object.

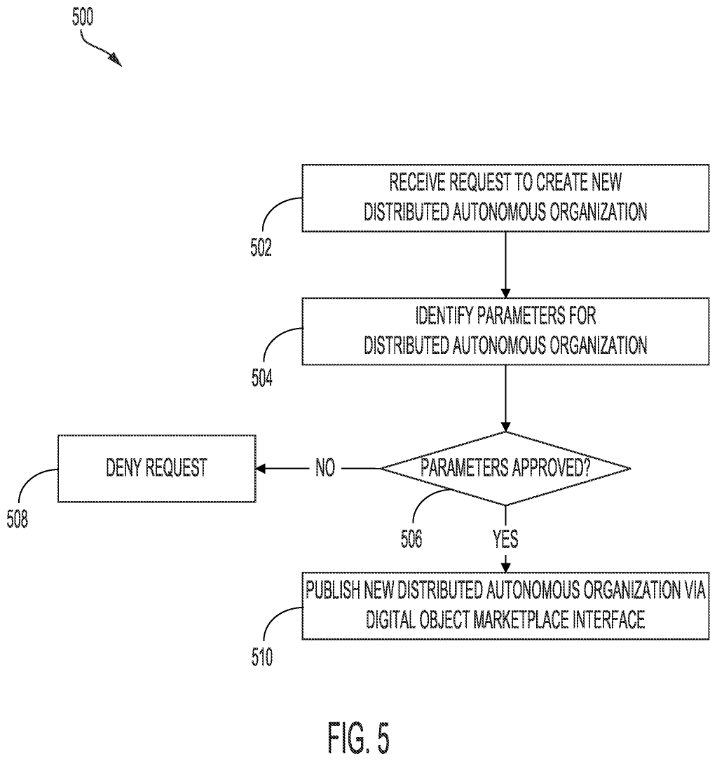

FIG. 5 shows an illustrative example of a process 500 for creating a new DAO in accordance with at least one embodiment. The process 500 may be performed by a DAO creation system of the digital object marketplace, such as the DAO creation system 204 described above in connection with FIG. 2. Further, the process 500 may be performed in conjunction with a DAO management system and a decentralized distributed ledger that may be used to deploy a smart contract for the new DAO as described herein.

At step 502, the DAO creation system may receive a request to create a new DAO. As noted above, a user of the digital object marketplace may submit a request to the digital object marketplace to initialize the creation of a DAO. The user may define a purpose statement or other description for the DAO that is to be created, specify the minimum number of investors that may join the DAO, and the minimum investment amount required from the investors in order to successfully launch the DAO. The minimum investment amount may be defined using units of a cryptocurrency or of a fiat currency. In some instances, the user may define a minimum investment amount for each investor that wishes to join the DAO in addition to the minimum investment amount required from the investors in total in order to successfully launch the DAO. Further, in some instances, the user may define a maximum investment amount or threshold for each investor that wishes to join the DAO. This maximum investment amount or threshold may be implemented to prevent any one investor from monopolizing the DAO.

At step 504, the DAO creation system may identify the parameters for the new DAO. For instance, the DAO creation system may review the request from the user to create the new DAO and obtain the various parameters defined by the user for the DAO. These parameters may include those described above (e.g., purpose statement or description for the DAO, minimum number of investors that may join the DAO, minimum investment amount required from the investors in order to successfully launch the DAO, minimum investment amount for each investor that wishes to join the DAO, maximum investment amount or threshold for each investor, etc.).

At step 506, the DAO creation system may determine whether the parameters for the new DAO may be approved. For instance, creation of a new DAO may be subject to one or more applicable regulations that may govern the implementation and management of DAOs.

Additionally, or alternatively, the digital object marketplace may define one or more guidelines for establishing a new DAO within the digital object marketplace. If the DAO creation system determines that the parameters corresponding to the new DAO that is to be created do not satisfy the applicable regulations and/or guidelines for creating a new DAO within the digital object marketplace, the DAO creation system, at step 508, may deny the request to create the new DAO.

At step 510, if the DAO creation system determines that the parameters for the new DAO are approved, the DAO creation system, via a DAO management system of the digital object marketplace, may publish the new DAO via the digital object marketplace interface. For instance, the DAO management system may publicly list the new DAO via a website or web portal provided by the digital object marketplace. This may allow users of the digital object marketplace to view any open DAOs and determine whether to invest in a particular DAO. Further, the DAO management system may generate an object fund pool for the DAO, which may be used to pool investments from any investor joining and contributing to the DAO. In an embodiment, the object fund pool for the open DAO may be maintained via a decentralized distributed ledger. For instance, the DAO management system may create a digital wallet for the DAO via the decentralized distributed ledger that may be used as the object fund pool for the DAO. In addition to generating a digital wallet for the DAO, the DAO creation system, via a DAO management system, may deploy a smart contract to the decentralized distributed ledger for the DAO. For instance, in response to the user's request to create a new DAO, the DAO management system may map the parameters for the DAO to a smart contract.

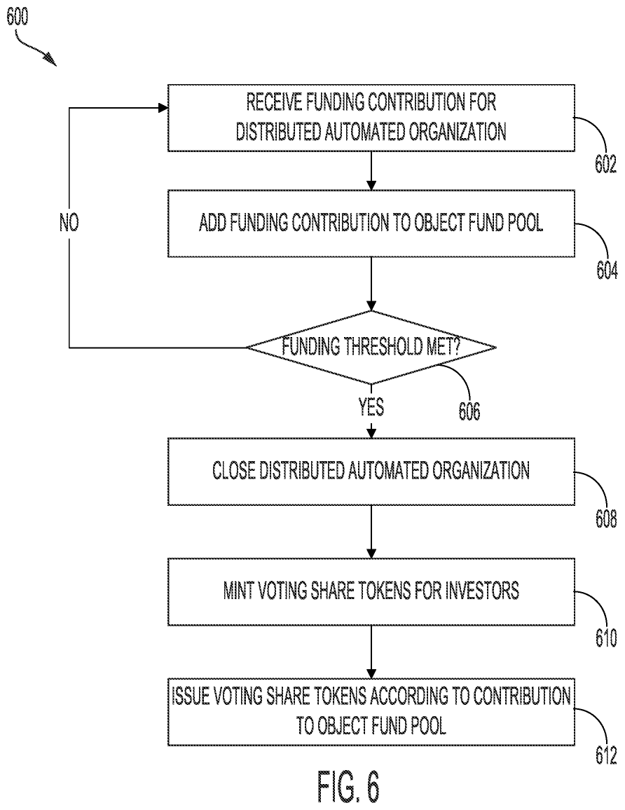

FIG. 6 shows an illustrative example of a process 600 for issuing voting share tokens to investors associated with a DAO in response to a determination that a funding threshold for the DAO has been met in accordance with at least one embodiment. The process 600 may be performed by a DAO management system, such as DAO management system 206 described above in connection with FIG. 2, in conjunction with a smart contract deployed to a decentralized distributed ledger for the DAO.

At step 602, the DAO management system may receive a funding contribution for the DAO from a potential investor. As noted above, the DAO management system may allow investors to contribute to the DAO using an amount of cryptocurrency and/or fiat currency. When an investor submits a request to the DAO management system to invest in the DAO, the DAO management system, at step 604, may transmit a payment request to a payment processing system of the digital object marketplace for incorporation of the investment into the object fund pool for the DAO and to obtain any corresponding voting share tokens according to the terms specified in the smart contract. For instance, the payment processing system, via the DAO management system, may transmit the investment request and an identity token corresponding to the investor's digital wallet to the smart contract deployed to the decentralized distributed ledger for processing of the investment.

It should be noted that, in some instances, the smart contract may additionally determine whether the investment may be accepted and incorporated into the object fund pool for the DAO. For instance, if the investment amount exceeds the maximum threshold amount for the DAO, the investment may be rejected. Similarly, if the investor has previously submitted an investment to the DAO, the new investment may also be rejected. As another example, if the investor has already contributed an amount to the DAO (through any number of contributions) up to a personal maximum contribution threshold, the new investment may be rejected. As yet another example, if processing of the investment would result in the investor having a voting share greater than a maximum threshold amount, the investment may also be rejected by the smart contract.

At step 606, the smart contract deployed to the decentralized distributed ledger for the DAO may determine whether a funding threshold has been met for the DAO. For instance, as investors submit investment contributions to the DAO, the smart contract may determine whether the DAO has reached its funding threshold. For example, as investments are received for the DAO, the smart contract may track the total investment amount submitted and the contribution of each investor made to the DAO. As noted above, the smart contract can automatically provide, to the DAO management system, the percentage of the total investment amount received that each investor has contributed and, accordingly, is entitled to. This information may be provided by the DAO management system to all investors of the DAO, as well as to any user of the digital object marketplace that may be interested in investing in the DAO. If the funding threshold has not been met, the DAO management system may continue to solicit and process new investments, thereby restarting the process 600.

In an embodiment, the DAO management system can impose a time limit for achieving the funding threshold for the DAO. For example, the DAO management system may continue to solicit and process new investments up to a predefined time limit (as defined by a DAO creator or by default by the digital object marketplace). If the funding threshold is not met at the end of the time limit for soliciting and processing new investments for the DAO, the DAO management system may determine that the DAO has not been funded. As a result, the DAO may be automatically terminated, and funds invested by investors may be returned to investors. In some instances, if the time limit was imposed by the DAO creator, the DAO management system may transmit a notification to the DAO creator indicating that the time limit has elapsed. Accordingly, the DAO creator may determine whether to terminate the DAO or to extend the time limit for soliciting and processing investments to the DAO.

If the funding threshold for the DAO has been reached, the smart contract may, at step 608, close the DAO such that no more investments may be committed to the DAO. This may result in the DAO being de-listed from the digital object marketplace as being open for investment. Further, at step 610, the smart contract may mint voting share tokens for the investors according to their corresponding investments to the DAO. In an embodiment, the smart contract can mint a voting share token for each investor, whereby a voting share token for a particular investor may encode the investor's voting power or share. An investor's voting power or share may correspond to the contribution of the investor to the object fund pool for the DAO. As a result, some voting share tokens may provide greater voting power compared to others. In some instances, rather than minting a voting share token for each investor, the smart contract can mint voting share tokens in proportion to the total funding amount in the object fund pool. Each investor may receive a number of voting share tokens proportional to the amount invested by the investor.

At step 612, the smart contract may issue the newly minted voting share tokens to the investors according to their contribution to the object fund pool. For instance, the smart contract may transfer voting share tokens to the digital wallets of the investors such that each investor may maintain, in its digital wallet, a number of voting share tokens that may be submitted when a vote is being tallied for the DAO.

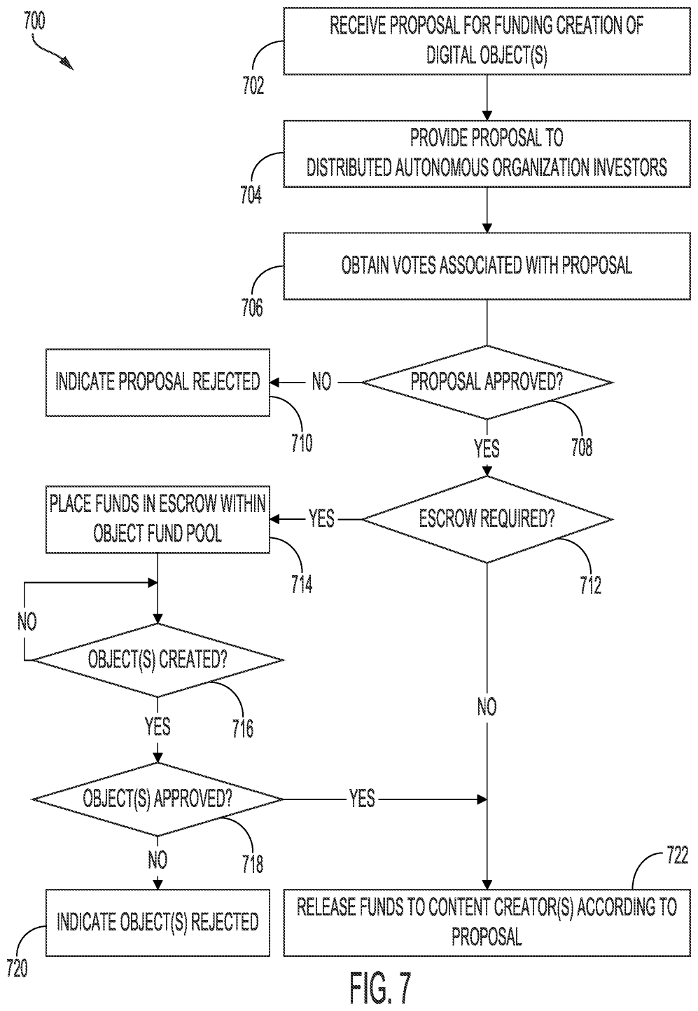

FIG. 7 shows an illustrative example of a process 700 for approving a DAO proposal and allocating funds from the DAO to one or more content creators for the publishing of digital objects to the digital object marketplace in accordance with at least one embodiment. The process 700 may be performed by the DAO management system of the digital object marketplace, in conjunction with a payment processing system of the digital object marketplace and a smart contract deployed to a decentralized distributed ledger for the DAO.

At step 702, the DAO management system may receive a proposal for funding creation of one or more digital objects that may be published to the digital object marketplace. As noted above, an investor, through the DAO management system, can submit proposals on which projects or digital objects that may be published to the digital object marketplace the investor would like to see funded. For instance, investors may submit proposals to allocate an amount of funds from the object fund pool of the DAO to specific digital object types. As another example, investors may submit proposals to allocate an amount of funds from the object fund pool to individual content creators for the creation of digital objects. Investors may also submit proposals to allocate an amount from the object fund pool to independent developers, development studios, and other entities. In some embodiments, investors can submit proposals to generate a bounty to incentivize the development of different digital media, such as video games. In some instances, investors can also submit proposals to fund new franchises.

At step 704, in response to receiving a proposal from an investor associated with the DAO, the DAO management system may provide the proposal to the investors associated with the DAO. For instance, the DAO management system may notify the investors associated with the DAO of the new proposal and present this new proposal to the investors accordingly. For example, when a proposal is received for use of funds from the DAO, the DAO management system may automatically notify each investor associated with the DAO to indicate that a new proposal has been received. An investor may access the DAO management system to review the new proposal and determine whether to approve or reject the proposal.

At step 706, the DAO management system may obtain votes associated with the presented proposal from the investors associated with the DAO. For instance, when an investor reviews the proposal, the investor may determine whether to vote for or against the proposal using its voting share token(s). As each investor votes for or against the new proposal, the DAO management system may transmit these votes to the smart contract for the DAO, which may receive these votes and the voting share tokens for the investors.

The smart contract may, at step 708, determine whether the proposal has been approved. For instance, in order for a proposal to be approved, a minimum number of investors may be required for the vote on the proposal in order for the vote to be valid. In some instances, in order for a proposal to be approved, a quorum of investors may be required for the vote on the proposal to be valid. In yet other instances, the smart contract may determine whether a requisite amount of voting share power has been detected amongst the investors that have submitted votes in order to determine whether the vote on the proposal is valid. Thus, in order for the smart contract to determine whether the proposal is approved, it is to first determine whether one or more criteria for the vote to be considered valid have been satisfied. In some instances, the smart contract may impose a time limit for receiving votes from investors for a proposal. If an investor fails to provide a vote within the time limit, the investor may be considered as having abstained from voting on the proposal and its vote and voting share are ignored by the DAO management system and the smart contract. Once the time limit has passed, the smart contract may determine whether the one or more criteria for the vote to be considered valid have been satisfied. If the one or more criteria for the vote to be considered valid have not been satisfied, the smart contract may, at step 710, indicate that the proposal has been rejected and transmit a notification to the DAO management system to indicate that the proposal has been rejected by the DAO. In some instances, the DAO management system, in response to this indication, may transmit a notification to the investors associated with the DAO to indicate that the proposal has been rejected.

If the one or more criteria required for the vote on the proposal to be valid are satisfied, the smart contract may proceed to determine whether the proposal has been approved by the set of investors. For instance, the smart contract may process each received vote, as well as the corresponding voting share token(s) corresponding to the vote, and tally these votes according to their corresponding voting shares to determine whether the proposal has passed. As noted above, approval of a proposal may be subject to one or more requirements as defined by a DAO creator, as agreed upon by the investors, or as defined by default by the digital object marketplace. If the proposal is rejected by the investors, the smart contract may, at step 710, indicate that the proposal has been rejected, as described above.

If the proposal has been approved by the investors associated with the DAO, the smart contract may, at step 712, determine whether escrow is required for the funds required for the proposal in the object fund pool. As noted above, a proposal may require a content creator or independent developer to submit digital objects for review to the DAO before funds allocated for the proposal can be released from escrow to the content creator or independent developer. If the disbursement of funds requires approval of submitted digital objects, the smart contract may determine that funds in the object fund pool are to be placed in escrow for the proposal. Thus, at step 714, the smart contract may place the funds from the digital wallet associated with the DAO in escrow in the object fund pool until a content creator or independent developer submits the required digital objects to an object management system of the digital object marketplace for publishing of the digital objects.

At step 716, the object management system may determine whether a content creator or independent developer has submitted one or more digital objects according to the proposal. If the object management system determines that no new digital objects have been created and submitted for review, the funds in the object fund pool may remain in escrow. However, if the object management system receives one or more digital objects from a content creator or independent developer for fulfillment of the proposal, the object management system, via the DAO management system, may provide these digital objects to the investors associated with the DAO for review. For instance, the DAO management system may notify the investors of the DAO that the content creator has uploaded these digital objects to the object management system for review and approval.

At step 718, the object management system may determine whether the digital objects provided by the content creator has been approved by the investors of the DAO. For instance, the investors may review the digital objects and vote to approve or deny the disbursement of funds from the object fund pool to the content creator or independent developer for the digital objects. If the investors vote to reject the digital objects provided by the content creator, the object management system, at step 720, may indicate that the digital objects have been rejected. For instance, the object management system may transmit a notification to the content creator to indicate that the DAO has rejected the provided digital objects. Additionally, or alternatively, the object management system can transmit a notification to the investors of the DAO to indicate that the provided digital objects have been rejected by the DAO.

If the investors of the DAO approve the provided digital objects, the object management system may store the digital objects in a digital object store within a distributed file system. Further, the smart contract may, at step 722, release the funds from escrow in the object fund pool to the content creators according to the proposal. For instance, the smart contract may transfer the funds from the digital wallet associated with the object fund pool to the digital wallet of the content creator or independent developer according to the terms specified in the proposal. However, this transfer of funds at step 722 from the digital wallet associated with the object fund pool to the digital wallet associated with the content creator or independent developer may occur without the object review process described above in connection with step 716 if the proposal does not require such investor approval, and funds may be dispersed automatically upon the approval of the proposal in step 708. This transfer may be recorded in the decentralized distributed ledger.

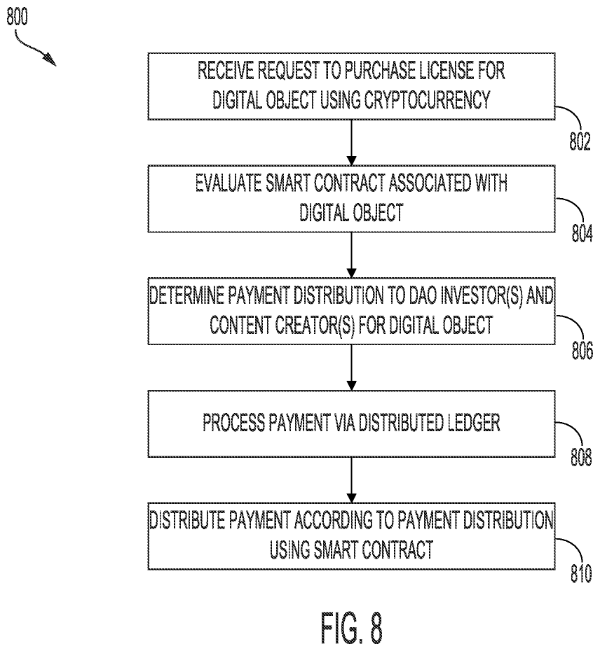

FIG. 8 shows an illustrative example of a process 800 for distributing financial distributions to investors associated with a DAO in response to receiving a payment for a license token associated with a digital object created using funds from the DAO in accordance with at least one embodiment. The process 800 may be performed by the digital object marketplace. Further, the process 800 may be performed in conjunction with a smart contract deployed in a decentralized distributed ledger and associated with the digital object for which a license is being purchased as described herein. This smart contract may further be associated with another smart contract associated with the DAO that provided the requisite funding for the creation of the digital object for which a license token is being obtained.

At step 802, the digital object marketplace may receive a request to purchase a license token for a digital object. For instance, a user of the digital object marketplace may access a landing page for a digital object and submit a request to purchase a license token for the particular digital object. The digital object may be standalone component (e.g., motion capture file, sound recording, icon, image, etc.) or a digital media (e.g., a video game, etc.).

At step 804, the digital object marketplace may evaluate the smart contract deployed to the decentralized distributed ledger and associated with the particular digital object for which the license token is being obtained. A smart contract for a digital object may serve as a type of account within the decentralized distributed ledger, whereby the smart contract may have a balance and may transmit transactions over a decentralized network. Further, the smart contract may function as programmed by the digital object marketplace. For instance, when users interact with the digital object marketplace to obtain a license token for the digital object, the digital object marketplace may interact with the smart contract by submitting transactions on behalf of users that execute one or more functions defined in the smart contract. The smart contract may indicate the number of available license tokens for the digital object, as well as the distribution chain for payments associated with the purchase of a license token. For instance, a digital object may be generated using funds from a DAO subject to a set of financial distribution terms. The smart contract for the digital object may utilize the financial distribution terms for the DAO (as specified in the smart contract for the DAO) to determine the distribution of a payment made for the purchase of a license token for the digital object.

At step 806, the smart contract for the digital object may determine the payment distribution to DAO investors and content creators for the digital object, as well as the available license tokens for the digital object. The smart contract for the digital object may make reference to the smart contract associated with the DAO, for which financial distribution terms have been defined. Through this other smart contract, the smart contract for the digital object may determine a distribution schema for payments made for the purchase of a license token for the digital object. This distribution schema may define percentages or fixed amounts of a payment that are to be distributed to the various DAO investors (according to their voting shares) and to the content creators of the digital object. In addition to defining a distribution schema for payments made for purchases of licensing tokens for the digital object, a smart contract can further specify the maximum number of licensing tokens generated and made available for the digital object. For instance, a content creator, when publishing the digital object to the digital object marketplace, may define the number of licensing tokens that may be made available for the digital object. Thus, from the smart contract, the digital object marketplace may determine the number of available licensing tokens and, if a bonding curve is defined for determining the price of a license token, the price for the license token.

At step 808, the smart contract may process the payment via the distributed ledger. For instance, an object licensing system of the digital object marketplace may transmit a payment request to a payment processing system of the digital object marketplace for processing and distribution of the user's payment to the content creator and the DAO investors according to the terms specified in the smart contract. The payment processing system may transmit the transaction request, the owner token held by the content creator or independent developer of the digital object, and an identity token corresponding to the purchaser's digital wallet to the smart contract for the digital object deployed in the decentralized distributed ledger for processing of the transaction. Alternatively, in the place of an owner token, a recipient wallet address designated to receive payments will be transmitted. The smart contract, at step 810, may distribute the payment according to the payment distribution schema specified therein. For instance, the smart contract may transfer portions of the payment to the digital wallets of the content creators associated with the digital object and to the DAO investors according to the defined distribution schema. The payment may be processed from the purchaser's digital wallet and the transaction may be recorded in the decentralized distributed ledger. Further, the smart contract may transfer a license token to the purchaser's digital wallet to complete the transaction.

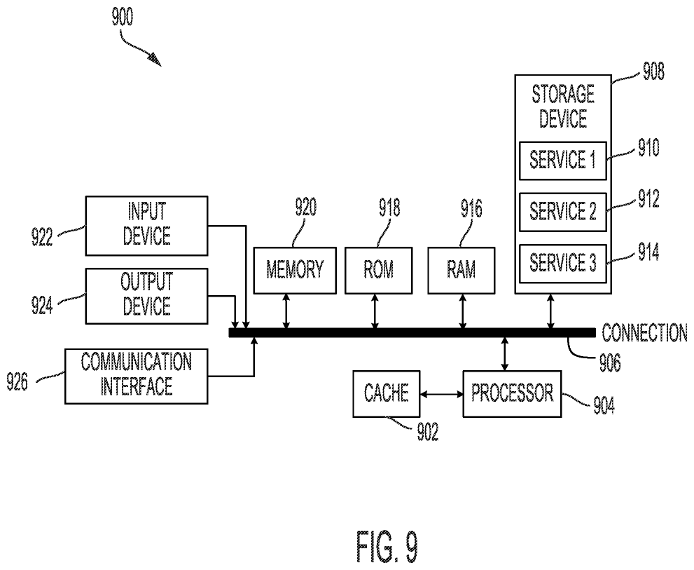

FIG. 9 illustrates a computing system architecture 900 including various components in electrical communication with each other using a connection 906, such as a bus, in accordance with some implementations. Example system architecture 900 includes a processing unit (CPU or processor) 904 and a system connection 906 that couples various system components including the system memory 920, such as ROM 918 and RAM 916, to the processor 904. The system architecture 900 can include a cache 902 of high-speed memory connected directly with, in close proximity to, or integrated as part of the processor 904. The system architecture 900 can copy data from the memory 920 and/or the storage device 908 to the cache 902 for quick access by the processor 904. In this way, the cache can provide a performance boost that avoids processor 904 delays while waiting for data. These and other modules can control or be configured to control the processor 904 to perform various actions.

Other system memory 920 may be available for use as well. The memory 920 can include multiple different types of memory with different performance characteristics. The processor 904 can include any general purpose processor and a hardware or software service, such as service 1 910, service 2 912, and service 3 914 stored in storage device 908, configured to control the processor 904 as well as a special-purpose processor where software instructions are incorporated into the actual processor design. The processor 904 may be a completely self-contained computing system, containing multiple cores or processors, a bus, memory controller, cache, etc. A multi-core processor may be symmetric or asymmetric.

To enable user interaction with the computing system architecture 900, an input device 922 can represent any number of input mechanisms, such as a microphone for speech, a touch-sensitive screen for gesture or graphical input, keyboard, mouse, motion input, speech and so forth. An output device 924 can also be one or more of a number of output mechanisms known to those of skill in the art. In some instances, multimodal systems can enable a user to provide multiple types of input to communicate with the computing system architecture 900. The communications interface 926 can generally govern and manage the user input and system output. There is no restriction on operating on any particular hardware arrangement and therefore the basic features here may easily be substituted for improved hardware or firmware arrangements as they are developed.

Storage device 908 is a non-volatile memory and can be a hard disk or other types of computer readable media which can store data that are accessible by a computer, such as magnetic cassettes, flash memory cards, solid state memory devices, digital versatile disks, cartridges, RAMs 916, ROM 918, and hybrids thereof. In some aspects, storage device 908 can be implemented and reside in a cloud (in physical and/or virtual form), which may include one or more cloud components in one or more networks, distributed ledger-based computing in a cloud, and the like.

The storage device 908 can include services 910, 912, 914 for controlling the processor 904. Other hardware or software modules are contemplated. The storage device 908 can be connected to the system connection 906. In one aspect, a hardware module that performs a particular function can include the software component stored in a computer-readable medium in connection with the necessary hardware components, such as the processor 904, connection 906, output device 924, and so forth, to carry out the function.

The disclosed methods can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks, distributed ledger-based computing in a cloud, and the like. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couple the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couple the processor to the network interface device. The interface can include one or more of a modem or network interface. It will be appreciated that a modem or network interface can be considered to be part of the computer system. The interface can include an analog modem, Integrated Services Digital network (ISDN0 modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
receiving a proposal for disbursement of funds from a decentralized autonomous organization (DAO) for creation of one or more digital objects, wherein the DAO is associated with a set of investors, and wherein the DAO is associated with a set of voting share tokens minted using a smart contract deployed to a distributed ledger for the DAO;
providing the proposal to the set of investors;
obtaining votes associated with the proposal, wherein a vote indicates a response to the proposal and includes one or more voting share tokens of the set of voting share tokens;
processing the votes associated with the proposal to determine whether the proposal is approved, wherein processing the votes includes evaluating voting share tokens submitted with the votes and corresponding responses to the proposal; and
as a result of the votes indicating that the proposal is approved, disbursing the funds from the DAO for the creation of the one or more digital objects, wherein the funds are disbursed by the smart contract from a digital wallet associated with the DAO.

2. The computer-implemented method of claim 1, wherein the set of voting share tokens are minted according to contributions made to the DAO, and wherein a voting share token indicates a voting share according to an amount of a contribution made to the DAO.

3. The computer-implemented method of claim 1, further comprising:
deploying a smart contract corresponding to the one or more digital objects to the distributed ledger, wherein the smart contract corresponding to the one or more digital objects defines a distribution of payments for the one or more digital objects to the set of investors.

4. The computer-implemented method of claim 1, wherein:
the funds are disbursed to a digital wallet associated with an object fund pool, wherein the object fund pool maintains the funds in escrow until the one or more digital objects are approved by the DAO; and
the computer-implemented method further comprises:
receiving the one or more digital objects;
providing the one or more digital objects to the DAO for approval of the one or more digital objects; and
disbursing the funds from the digital wallet associated with the object fund pool as a result of the one or more digital objects being approved by the DAO.

5. The computer-implemented method of claim 1, wherein the one or more voting share tokens are transferrable, and wherein when the one or more voting share tokens are transferred to another digital wallet, payments apportioned for the one or more voting share tokens are provided to the other digital wallet.

6. The computer-implemented method of claim 1, wherein the set of voting share tokens are minted and disbursed such that no investor of the set of investor has a majority stake in the DAO.

7. The computer-implemented method of claim 1, wherein the DAO is automatically created in response to a funding threshold for the DAO being met, and wherein the funding threshold is met when a minimum amount of contributions from the set of investors is received.

8. A system, comprising:
one or more processors; and
memory storing thereon instructions that, as a result of being executed by the one or more processors, cause the system to:
receive a proposal for disbursement of funds from a decentralized autonomous organization (DAO) for creation of one or more digital objects, wherein the DAO is associated with a set of investors, and wherein the DAO is associated with a set of voting share tokens minted using a smart contract deployed to a distributed ledger for the DAO;
providing the proposal to the set of investors;
obtain votes associated with the proposal, wherein a vote indicates a response to the proposal and includes one or more voting share tokens of the set of voting share tokens;
process the votes associated with the proposal to determine whether the proposal is approved, wherein processing the votes includes evaluating voting share tokens submitted with the votes and corresponding responses to the proposal; and
as a result of the votes indicating that the proposal is approved, disburse the funds from the DAO for the creation of the one or more digital objects, wherein the funds are disbursed by the smart contract from a digital wallet associated with the DAO.

9. The system of claim 8, wherein the set of voting share tokens are minted according to contributions made to the DAO, and wherein a voting share token indicates a voting share according to an amount of a contribution made to the DAO.

10. The system of claim 8, wherein the instructions further cause the system to:
deploy a smart contract corresponding to the one or more digital objects to the distributed ledger, wherein the smart contract corresponding to the one or more digital objects defines a distribution of payments for the one or more digital objects to the set of investors.

11. The system of claim 8, wherein:
the funds are disbursed to a digital wallet associated with an object fund pool, wherein the object fund pool maintains the funds in escrow until the one or more digital objects are approved by the DAO; and
the instructions further cause the system to:
receive the one or more digital objects;
provide the one or more digital objects to the DAO for approval of the one or more digital objects; and
disburse the funds from the digital wallet associated with the object fund pool as a result of the one or more digital objects being approved by the DAO.

12. The system of claim 8, wherein the one or more voting share tokens are transferrable, and wherein when the one or more voting share tokens are transferred to another digital wallet, payments apportioned for the one or more voting share tokens are provided to the other digital wallet.

13. The system of claim 8, wherein the set of voting share tokens are minted and disbursed such that no investor of the set of investor has a majority stake in the DAO.

14. The system of claim 8, wherein the DAO is automatically created in response to a funding threshold for the DAO being met, and wherein the funding threshold is met when a minimum amount of contributions from the set of investors is received.

15. A non-transitory, computer-readable storage medium storing thereon executable instructions that, as a result of being executed by one or more processors of a computer system, cause the computer system to:
receive a proposal for disbursement of funds from a decentralized autonomous organization (DAO) for creation of one or more digital objects, wherein the DAO is associated with a set of investors, and wherein the DAO is associated with a set of voting share tokens minted using a smart contract deployed to a distributed ledger for the DAO;
providing the proposal to the set of investors;
obtain votes associated with the proposal, wherein a vote indicates a response to the proposal and includes one or more voting share tokens of the set of voting share tokens;
process the votes associated with the proposal to determine whether the proposal is approved, wherein processing the votes includes evaluating voting share tokens submitted with the votes and corresponding responses to the proposal; and
as a result of the votes indicating that the proposal is approved, disburse the funds from the DAO for the creation of the one or more digital objects, wherein the funds are disbursed by the smart contract from a digital wallet associated with the DAO.

16. The non-transitory, computer-readable storage medium of claim 15, wherein the set of voting share tokens are minted according to contributions made to the DAO, and wherein a voting share token indicates a voting share according to an amount of a contribution made to the DAO.

17. The non-transitory, computer-readable storage medium of claim 15, wherein the executable instructions further cause the computer system to:
deploy a smart contract corresponding to the one or more digital objects to the distributed ledger, wherein the smart contract corresponding to the one or more digital objects defines a distribution of payments for the one or more digital objects to the set of investors.

18. The non-transitory, computer-readable storage medium of claim 15, wherein:
the funds are disbursed to a digital wallet associated with an object fund pool, wherein the object fund pool maintains the funds in escrow until the one or more digital objects are approved by the DAO; and
the executable instructions further cause the computer system to:
receive the one or more digital objects;
provide the one or more digital objects to the DAO for approval of the one or more digital objects; and
disburse the funds from the digital wallet associated with the object fund pool as a result of the one or more digital objects being approved by the DAO.

19. The non-transitory, computer-readable storage medium of claim 15, wherein the one or more voting share tokens are transferrable, and wherein when the one or more voting share tokens are transferred to another digital wallet, payments apportioned for the one or more voting share tokens are provided to the other digital wallet.

20. The non-transitory, computer-readable storage medium of claim 15, wherein the set of voting share tokens are minted and disbursed such that no investor of the set of investor has a majority stake in the DAO.

21. The non-transitory, computer-readable storage medium of claim 15, wherein the DAO is automatically created in response to a funding threshold for the DAO being met, and wherein the funding threshold is met when a minimum amount of contributions from the set of investors is received.
